(19) United States
(12) Patent Application Publication
(10) Pub. No.: US 2002/0141476 A1
(43) Pub. Date: Oct. 3, 2002

(54) Electrode joint

(76) Inventor: William Varela, Parma Heights, OH (US)

Correspondence Address: JAMES R. CARTIGLIA, UCAR CARBON COMPANY, INC., BRANDYWINE WEST, 1521 CONCORD PIKE, SUITE 301, WILMINGTON, DE, 19803, US

(21) Appl. No.: 09/819,491

(22) Filed: Mar. 28, 2001

(51) Int. Cl. H05B 7/14

(52) U.S. Cl. 373/92; 373/88

(57) ABSTRACT

A carbon or graphite electrode comprising a first end having a planar surface and a second end having a second planar surface. The first planar surface has a male dovetailed tenon projecting therefrom. The second planar surface has a female dovetailed groove dimensioned for snugly receiving and engaging the male dovetail tenon. The male dovetail tenon has the same shape and dimension of the female dovetail groove so that the two, when joined, form a snug dovetail joint. Also disclosed is a joint for a carbon or graphite electrode in an electrode column.

### FIELD OF THE INVENTION

The present invention relates to carbon or graphite electrode columns that have a stronger joint that is easier to join than traditional threaded joints.

### BACKGROUND OF THE INVENTION

Carbon electrodes, especially graphite electrodes, are used in the steel industry to melt the metals and other ingredients used to form steel in electrothermal furnaces. The heat needed to melt the metals is generated by passing current through at least one electrode, usually three, and forming an arc between the electrodes and the metal. The heat that is developed by the electric arc not only melts the metal, but also gradually consumes the electrode. Because it is necessary to maintain a controlled arc length, the electrode used is present in a multiple-electrode column, and the electrode column must be fed down into the furnace to compensate for the electrode consumption. Therefore, it is necessary to continuously feed the electrode into the furnace in order to maintain the arc. Eventually, as the electrode is consumed, a new electrode section is added by joining it to the upper end of the old electrode section to form the electrode column. Thus, adequate electrode length is assured by adding new electrode sections to the top of the electrode column which protrudes through the furnace roof.

A common method of joining the two electrode sections together is by use of a threaded nipple. The nipple is screwed into correspondingly threaded sockets provided in the end faces of the two electrode sections. Also, the nipple may comprise a machined threaded male surface at the end of the electrode. The opposite end of the electrode may have a threaded female surface to receive a corresponding male end. The threaded portions may be cylindrical. In most applications a tapered, threaded nipple is used for its superior strength.

This type of electrode column is both effective and popular in use, but has been the source of many problems. One such problem is the fact that the electrodes may occasionally at least partially unscrew from each other, which creates loose joints. The occurrence of loose joints can be a major problem resulting in high electrical resistance (which can create a “hot spot” and contribute to joint failure), increased electrode consumption, and weaker joints. Furthermore, loose joints are subject to increased vibration, which can contribute to mechanical failure.

The joining of electrode sections in a steel mill environment is often performed without the aid of sophisticated devices. In such a situation, the mill operator will typically first suspend a fresh electrode from a crane and axially align the fresh electrode over the electrode column section protruding from the furnace roof. The operator will then longitudinally downwardly advance the fresh electrode toward the electrode column. In one method of joining, the operator will lower the fresh electrode without rotation until its threads make contact with the threads of the electrode column section. He will then commence to screw the two electrodes together. In another method of joining, the operator will commence rotating the fresh electrode about its longitudinal axis before the threads make contact to screw the electrodes together.

The operator normally rotates the fresh electrode manually with the aid of an electrode turning fixture, for example, a chain wrench. The operator may also utilize a threaded stem device between the crane and the fresh electrode which, when fitted with a screw thread that has the same pitch as that of the threaded joints, allows the operator to longitudinally advance and rotate the fresh electrode toward the electrode column at the exact rate of advancement of the electrode threads.

Even with the aid of a crane and turning devices, the joining of the threaded electrode section ends does not always proceed smoothly. The great size and weight of the electrode sections (typically up to about 30 inches or greater diameter and about two tons or more weight for graphite electrodes, and about 55 inches diameter and about 15,000 lbs. weight for carbon electrodes) necessitate the use of large cranes or hoists which generally have imprecise controls and which therefore cannot locate the section with a great deal of precision. In addition, because tapered threads are used, the threaded projection of one electrode must be inserted deep into the threaded socket of the other electrode and out of easy view of the operator before the threads align and mate. The result of this practice is that the joining of the complimentarily threaded section ends is accomplished with much repositioning and inadvertent bumping and scraping between the threads at each end. This can lead to thread breakage.

The aforementioned problem of inadvertent bumping and scraping and possible breakage of threads can occur even if the two electrode sections to be joined are held in perfect axial alignment during joining. This may occur if the properly aligned fresh electrode section is advanced toward the electrode column with or without rotation of the fresh electrode section about its longitudinal axis. The thread crest of one electrode may not properly mate with the thread root of the other electrode and instead the thread crests of the two electrodes may become jammed, i.e., locked in wedged engagement with each other. It may also occur if the threaded stem is used and advancement and rotation are not begun with the proper longitudinal distance between complimentary thread points (the center of a thread crest on the projection and the center of a thread root in the socket, for example). If this distance is not equal to an integer multiple of the electrode thread pitch, thread crests of the projection and socket may become jammed.

At this point in the process, the operator is faced with the problem of freeing the jammed threads. Because of the difficulty of reversing a chain wrench (the usual electrode turning fixture) and the great force required, the operator will not normally attempt to unscrew the overhead fresh electrode. More commonly, the operator will use the crane to jog the upper fresh electrode up or down relative to the electrode column to unjam the thread crests. Once the threads are unjammed, the process is restarted and the fresh electrode is again moved in an attempt to align the thread crests and roots in proper longitudinal relationship. When the thread crests and roots of the two electrode sections are correctly aligned, they may be screwed together properly.

Since the threads (and the electrodes) are made of carbon or graphite which are relatively fragile materials as compared to metals, jogging the electrodes to free jammed threads can cause fragments of the threads to break off. If this occurs, one resulting problem is that the thread strength of the joint is weakened. An even greater problem arises if the thread fragments are trapped between the two threaded sections, preventing proper engagement of mating threads. This can easily occur when, as is normally the case, the fresh electrode section overhead has the threaded projection (either integral with the electrode section or as a threaded connecting pin screwed into a threaded socket) and the end of the electrode column below and protruding from the roof contains the threaded socket. Fragments can still be trapped if the positions of the thread projection and socket are reversed. The faulty connection will result in, among other things, an increase in electrical resistance which causes excess heating and thermal stress. Electrode column vibration during furnace operation may result in further problems by causing the trapped thread fragments to break into smaller pieces, thereby loosening the joint. The loose joint will be weak and susceptible to full unscrewing of the lower column section.

Previous attempts have been made to solve the aforementioned threaded joint problems. For example, U.S. Pat. No. 2,828,294 to Johnson discloses a pitch-filled reservoir located within each end of the electrode nipple and channels to distribute melted pitch upon heating. The system was designed such that the pitch would fill the void spaces between the nipple and socket threads. Upon further heating, the pitch cokes or carbonizes, solidly cementing the joint and providing a stronger bond between the electrode sections. This method was not completely effective because vibration of the electrode column frequently overcame the resistance provided by the pitch coke.

Foaming agents that expand when heated have been added to the pitch to force the pitch out of the reservoir and provide better contact between the pitch and the threaded joint. For example, see U.S. Pat. No. 4,007,324 to Wallouch. However, the degree of swelling was limited and there appeared to be no dramatic effect on the coking reaction or time required to implement a bond between the nipple and the socket threads.

U.S. Pat. No. 4,725,161 to Dagata discloses a reservoir containing a cementitious bonding material comprising pitch particles and foaming agent selecting from the group consisting of sulfur, nitrated decant oil, 2,4-dinitroanoline and mixtures thereof. The cementitious bonding material may also include about 1 to 20 weight percent coarse particles of coke, carbon, or graphite to increase the unscrewing resistance of the pitch-covered joint prior to coking The addition of sulfur was found to provide better coating and increased the bond strength between the nipple and the socket.

U.S. Pat. No. 4,729,689 discloses an electrode joint member with cementing pitch that is adhered to and/or impregnated within at least a portion of an electrode joint surface.

### SUMMARY OF THE INVENTION

It is an object of the present invention to provide a carbon or graphite electrode that has a stronger joint that is easier to join than the traditional threaded joints.

It is a another object of the present invention to provide a method of joining electrodes, with the resulting joined electrodes having a stronger joint that is easier to assemble than the traditional threaded joints.

More specifically, an object of the present invention is to provide an electrode column comprising a first electrode segment and a second electrode segment. The first electrode segment has a tenon extending from a first end. The second electrode segment has a mortise defined in its second end. The column is formed when the tenon is received in the mortise to form a dovetail joint connecting the first and second electrode segments.

An additional embodiment of the invention is to provide a carbon or graphite electrode comprising a first end having a planar surface and a second end having a second planar surface. The first planar surface has a male dovetailed tenon projecting therefrom. The second planar surface has a female dovetailed groove dimensioned for snugly receiving and engaging the male dovetail tenon. The male dovetail tenon has the same shape and dimension of the female dovetail groove so that the two, when joined, form a snug dovetail joint.

Another embodiment of the invention is to provide a joint for a carbon or graphite electrode in an electrode column. In one embodiment the joint comprises a first carbon or graphite or electrode segment having a first planar surface, and a second carbon or graphite electrode segment having a second planar surface. In this embodiment, a male dovetail tenon having a first end a second end and two side walls projects from the first planar surface. Furthermore, a female dovetail mortise is located in the second planar surface dimension for receiving and engaging with the male dovetail tenon. The tenon and the mortise snugly secure the first carbon or graphite electrode and a second or carbon or graphite electrode.

Additionally, an embodiment of the present invention includes a column suspension structure. The column suspension structure has a longitudinal axis and a first electrode section having a first planar surface sloped at first angle relative to the longitudinal axis. This angle is also known, with respect to the present invention, as the angle of slope. A tongue protrudes from the first planar surface of the first electrode. A second electrode section has a second planar surface with an angle of slope substantially equal to the angle slope of the first electrode section. The second electrode section also has a partially closed groove corresponding in dimension with the tongue. This groove is disposed in the second planar surface. The tongue and groove are slidably mated in frictional and structural interlock to form the column suspension structure of this embodiment.

### BRIEF DESCRIPTION OF THE DRAWINGS

FIG. 1 shows an electrode column having a carbon or graphite threaded electrode joint between two electrode segments like that of FIG. 2.

FIG. 2 shows a carbon or graphite electrode of the present invention with a tenon or tongue projecting from the first end and a mortise or groove defined in the second end.

FIG. 3 shows a side view of a carbon or graphite electrode of the present invention with an angle of slope of 75°.

FIG. 4 shows a top view of a carbon or graphite electrode of the present invention. The view is above an end with a tenon or tongue projecting therefrom.

FIG. 5 shows a side angle view of a carbon or graphite electrode of the present invention, with the tenon at the first end and the mortise at the second end being visible.

FIG. 6 shows a side cutaway view of a carbon or graphite electrode of the present invention. The dovetail angle formed by the side walls of the tenon or tongue is visible.

FIG. 7 is a view similar to FIG. 6, showing an electrode having grooves formed in the sidewalls of the tenon and the mortise.

### DETAILED DESCRIPTION OF THE INVENTION

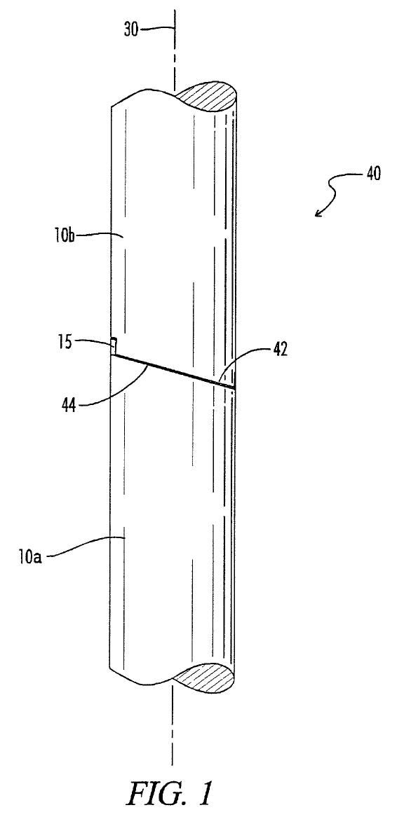

As shown in FIG. 1, the present invention includes an electrode column 40 having a first electrode segment 10a with a first end 42 and a tenon 15 extending from the first end 42. The electrode column 40 also contains a second electrode segment 10b having a second end 44 with a mortise 20 defined in the second end 44. The column 40 is formed when the tenon 15 is received in the mortise 20 to form a dovetail joint connecting the first and second electrode segments. A carbon or graphite electrode made in this manner is easier to join than the traditional threaded joints. The strength of the electrode joint is important because of, as discussed above, the conditions under which the electrodes are used and the great size and weight of the electrode sections. Additionally, the ease of joining is important because of the size of the electrode and equipment, and the adverse conditions associated with the heat surrounding the electrode thermal furnaces. A dovetail-style joint of the present invention is easier to attach to form an electrode column during mill conditions than the traditional alignment and joining of the threaded nipples of prior art electrode columns.

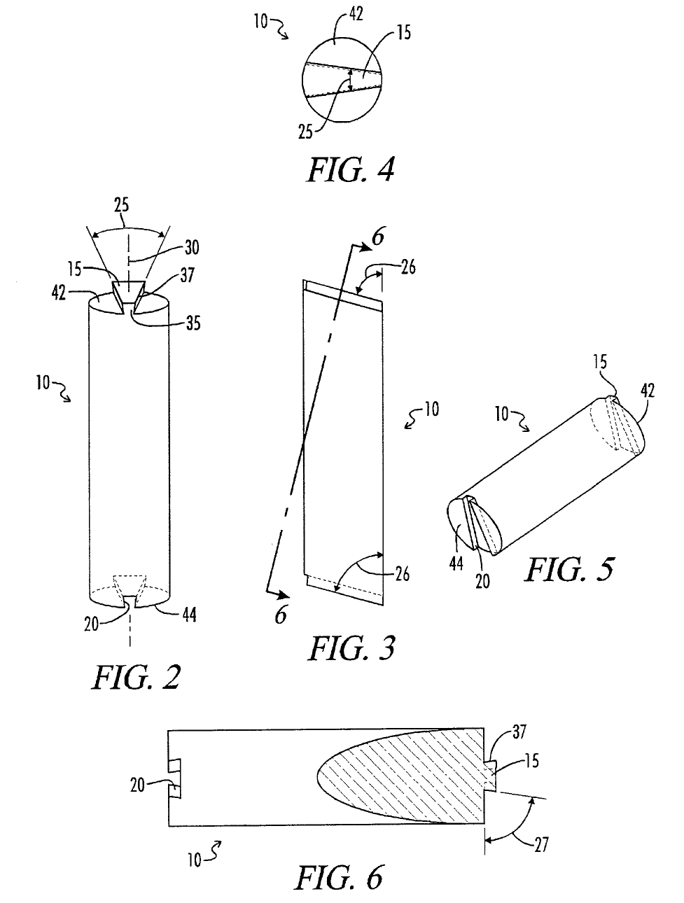

Preferably, the electrode columns of the present invention are cylindrical. Additionally, preferably both the tenon or tongue and the mortise each extend diagonally across their respective electrode segment ends. For example, see FIG. 2, where the electrode segment 10 is depicted as being cylindrical and the tenon 15 and mortise 20 each extend diagonally across their respective segment ends.

An angle of taper 25 may be formed by the tenon 15 and the mortise 20 so that when the tenon slides into the mortise there is defined a fully inserted position wherein the tenon is wedged into the mortise.

Typically, the angle of taper is in the range from about 10° to about 20°. Preferably, the angle of taper is from about 14° to about 16°. The angle of taper 25 also may be viewed in FIG. 4. Additionally, in FIG. 4 the view is from the top of an electrode segment 10 looking down on a tenon 15.

Preferably, when the tenon is inserted into the mortise, the electrodes form a snug fit. Preferably, in the fully inserted position of the tenon and the mortise, a longitudinal central axis 30 of the first electrode segment is substantially coincident with a longitudinal central axis of the second electrode segment. The longitudinal central axis 30 can be seen in FIGS. 2, 3, and 5.

Additionally, as seen in FIG. 3, the tenon 15 and mortise 20 are each sloped with an angle of slope 26 at an angle in the range of from about 60° to about 85° relative to the longitudinal central axis 30 of the electrode column 10, and more preferably, this angle of slope 26 is about 75°. The shape of the tenon and mortise relative to a longitudinal central axis of the electrode column together with the angle of slope causes gravity to assist the tenon being fully wedged into its fully inserted position in the mortise.

The present invention also includes a carbon or graphite electrode having a first end 42 with a first planar surface and a male dovetail tenon 15 projecting from the first planar surface. The electrode also has second end 44 having a second planar surface and a female dovetailed groove 20 in the second planar surface. The female dovetailed groove is dimensioned for snugly receiving and engaging a male dovetail tenon that has the same shape and dimension. Preferably, in the carbon or graphite electrodes of the present invention, the male dovetail tenon has first end, second end, and two lateral side walls joining the first and second ends. Typically, the first end is shorter in length than the second end to form a tapered dovetailed tenon. This arrangement is depicted in FIG. 2 with the first end 35 and a lateral side wall 37. The second end is not shown. The angle of the side walls of the tenon or tongue form a dovetail angle 27 as shown in FIG. 6. The dovetail angle may be at about a 72° to 85° angle to the first planar surface. Preferably, the dovetail angle is approximately 80°.

The side walls 37 may optionally be grooved or notched to assist in obtaining a snug engagement between the mortise and the tenon.

Additionally, the joint for a carbon or graphite electrode of the present invention may further comprise bonding cement used with the tenon or mortise to assist in obtaining a secure engagement between the tenon and the mortise. The nature of the bonding cement is not known to be critical, and any bonding cement known in the art for the purpose of bonding carbon or graphite electrodes may be used. An example of a cement that can be used in the inventive joint is a heat curable carbonaceous cement composition comprising a catalyst, a carbon filler, and a polymerizable monomeric binder system in a furan derivative solvent.

As stated above, an embodiment of the present invention is a column suspension structure that comprises at least two electrode sections. The sections are joined by a tongue 15 protruding for a top planar surface of one electrode and a corresponding partially closed groove 20 defined in a planar surface of the second electrode. The planar surfaces are sloped at an angle 26 relative to the longitudinal axis 30 of the column suspension structure (i.e., an angle of slope), and the tongue and the corresponding groove are slidably mated in frictional interlock. Although the tongue 15 and groove 20 are illustrated as tapered dovetail shapes, they could comprise other interlocking shapes such as a cylindrical tongue received in a partially closed cylindrical groove

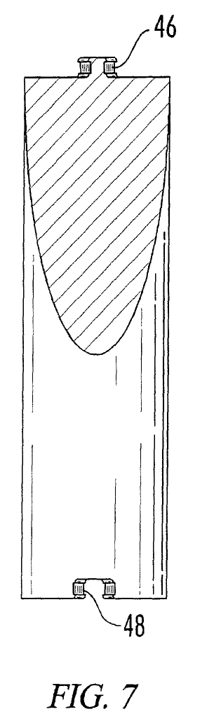

As with other embodiments, the tongue may have an angle of taper. That is, the tongue may comprise a front surface and a rear surface that varies in length compared to the front surface. The front and rear surfaces are joined by side walls. As with other embodiments of the present invention, the side walls by be grooved or notched, as indicated at 46 and 48 in FIG. 7, to assist in providing a snug engagement. The surfaces of the tongue and corresponding shape of the groove may form a dovetail joint when interlocked.

All cited patents and publications referred to in this application are herein expressly incorporated by reference.

This invention thus being described, it will be obvious that the same may be varied in many ways. Such variations are not to be regarded as a departure from the spirit and scope of the present invention, and all such modifications as would be obvious to one of ordinary skill in the art are intended to be included within the scope of the following claims.

I claim:

1. An electrode column, comprising:
a first electrode segment having a first end with a tenon extending from the first end;
a second electrode segment having a second end with a mortise defined in the second end; and
wherein the tenon is received in the mortise to form a dovetail joint connecting the first and second electrode segments.

2. The column of claim 1, wherein the first and second electrode segments are cylindrical, and the tenon and mortise each extend diagonally across their respective electrode segment ends.

3. The electrode column of claim 1, further comprising:
an angle of taper formed by the tenon and mortise so that when the tenon slides into the mortise there is defined a fully inserted position wherein the tenon is wedged into the mortise.

4. The electrode column of claim 3, wherein:
in the fully inserted position of the tenon and the mortise, a longitudinal central axis of the first electrode segment is substantially coincident with a longitudinal central axis of the second electrode segment.

5. The electrode column of claim 3, wherein:
the tenon and the mortise are each shaped relative to a longitudinal axis of the electrode column, so that gravity causes the tenon to wedge into its fully inserted position in the mortise.

6. The electrode column of claim 5, wherein:
the tenon and mortise are each sloped with an angle of slope at an angle in the range of from 60° to 85° relative to the longitudinal axis of the electrode column.

7. The electrode column of claim 3, wherein:
the angle of taper is in the range of from 10° to 20°.

8. A carbon or graphite electrode, comprising:
a first end having a first planar surface, and a second end having a second planar surface;
a male dovetailed tenon projecting from the first planar surface;
a female dovetailed groove in the second planar surface dimensioned for snugly receiving and engaging with a male dovetailed tenon that has the same shape and dimension of the male dovetailed tenon at the first end, to form a dovetail joint.

9. The carbon or graphite electrode of claim 8, wherein the male dovetailed tenon has a first end, second end, and two lateral side walls joining the first and second ends, the first end being shorter in length than the second end to formed a tapered dovetailed tenon.

10. The carbon or graphite electrode of claim 9, further comprising a dovetail angle formed by the side walls being oriented at a 70 to 85 degree angle to the first planar surface.

11. The carbon or graphite electrode of claim 7, the first and second planar surfaces forming an angle of slope being oriented at a 60 to 85 degree angle to a longitudinal axis of the electrode.

12. A joint for a carbon or graphite electrode in an electrode column, comprising:
a first carbon or graphite electrode segment having a first planar surface, and a second carbon or graphite electrode segment having a second planar surface;
a male dovetailed tenon having a first end, second end, and two side walls projecting from the first planar surface; and
a female dovetailed mortise in the second planar surface dimensioned for receiving and engaging with the male dovetailed tenon to snugly secure the male dovetailed tenon to the female dovetailed mortise, forming a dovetail joint.

13. The joint for a carbon or graphite electrode of claim 12, further comprising bonding cement between the tenon and the mortise.

14. The joint for a carbon or graphite electrode of claim 12, the tenon having an angle of taper formed by varying width from the first end of the tenon to the second end of the tenon.

15. The joint for a carbon or graphite electrode of claim 12, further comprising an angle of slope formed by the first and second planar surfaces being oriented at a 60 to 85 degree angle to a longitudinal axis of the column.

16. The joint for a carbon or graphite electrode of claim 12, further comprising a dovetail angle formed by the side walls being oriented at a 75 to 85 degree angle to the first planar surface.

17. A column suspension structure having a longitudinal axis, comprising:
a first electrode section having a first planar surface sloped at a first angle relative to the longitudinal axis, and a tongue protruding from the planar surface;
a second electrode section having a second planar surface sloped relative to the longitudinal axis at a second angle substantially equal to the first angle, and a partially closed groove corresponding in dimension with the tongue and disposed in the second planar surface;
said tongue and groove being slidably mated in frictional and structural interlock.

18. The column suspension structure of claim 17, wherein the tongue comprises a front surface, a rear surface that varies in length compared to the front surface, and two lateral tapered surfaces connecting the front and rear surfaces.

19. The column suspension structure of claim 17, wherein the tongue and the groove form a dovetail joint.

20. The column suspension structure of claim 17, wherein the first angle is in a range of from 70 degrees to 85 degrees.
